(19) United States
(12) Patent Application Publication
(10) Pub. No.: US 2011/0067281 A1
(43) Pub. Date: Mar. 24, 2011

(54) Information sign, especially name plates, door plates or notice signs

(76) Inventor: Manfred Seeleitner, Oberndorf (AT)

(21) Appl. No.: 12/923,400

(22) Filed: Sep. 20, 2010

(30) Foreign Application Priority Data
Sep. 22, 2009 (AT) A 1492/2009

(51) Int. Cl. G09F 15/00

(52) U.S. Cl. 40/611.01

(57) ABSTRACT

An information sign, especially name plates, door plates or notice signs, comprising a base body made of frame parts and optionally a base plate, and a cover plate or decorative plate which can be inserted in the base body, wherein the cover plate or decorative plate can be lifted off by means of a lifting tool, preferably a suction pad, acting upon the outside surface, so that a forward bulging of the cover plate or decorative plate is produced and the same can be removed. Two opposite longitudinal or narrow sides of the preferably rectangular or square cover plate or decorative plate and the adjacent frame parts are provided with a groove-and-tongue latching connection which ensures a secure holding of the cover plate or decorative plate in the base body.

### BACKGROUND OF THE INVENTION

The invention relates to an information sign, especially name plates, door plates or notice signs, comprising a base body made of frame parts and optionally a base plate, and a cover or decorative plate which can be inserted in the base body, with the cover or decorative plate being able to be lifted off by means of a lifting tool acting upon the outside surface, preferably a suction pad, so that a forward bulging of the cover or decorative plate is produced and the same can be removed.

Apparatuses for accommodating data carriers such as name or door plates are used especially for identifying individual rooms in office buildings, residential buildings, schools, etc. Furthermore, notice signs with illustrations or pictograms are known, e.g. for identifying escape routes, safety hazards, etc. So-called exchangeable signs are mostly used in which the card-like data carrier can be exchanged. The cover plate needs to be removed for this purpose, the data carrier exchanged and the cover plate reinserted again. The cover plate should be easily removable, but should not fall out of the frame by fluctuations in temperature or vibrations. It is further desirable that the removal of the cover plate should not be too easy in order to prevent vandalism (e.g. disfigurement of the data carrier, etc.).

### DESCRIPTION OF THE PRIOR ART

Most known exchangeable signs meet these requirements only to an unsatisfactory extent. An exchangeable sign is known for example from AT 394.463 B which is used for the pricing of goods and for providing information on merchandise. The exchangeable sign consists of an outside body which comprises a frame and an enclosed rear wall, with a viewing window being exposed on the front side. A transparent compartment body can be inserted into the outside body through a lateral insertion opening, which compartment body comprises receiving compartments for card-like data carriers. Information on goods and pricing details are printed onto said data carriers. The information can be read through a viewing window of the transparent compartment body. Fastening means are arranged on the rear wall of the outside body, so that such an exchangeable sign could also be used as a door plate. An improper change made to the content of the display cannot be excluded however because the transparent flat body can be removed very easily from the lateral insertion opening and can be manipulated.

It is further known from DE 44 19 732 C2 to form an exchangeable sign from a flat base body which can be clipped into a rear wall with respective flexible receiving strips. The transparent base body comprises individual compartments in which card-like data carriers can be inserted.

An information sign is known from DE 93 18 261 U1, comprising a base plate and a transparent cover plate, in which the base plate has a recess in which the cover plate can be inserted with perfect fit, with the insert being disposed between the base plate and the cover plate. As can be seen in FIG. 2, the outside surface of the transparent cover plate forms a substantially flat plane with the adjacent frame elements and abuts in a seamless manner on the frame elements. The cover plate is provided with a ferromagnetic material which cooperates with magnets in the recess of the cover plate. A suction cup placed on the cover plate can be used for removing the cover plate.

An information sign with a transparent cover plate is further known from EP 1 258 854 A1. The cover area comprises magnetic strips at the edge, which magnetic strips cooperate with the metal base area of the information sign. A suction cup can be used for removing the cover plate.

### SUMMARY OF THE INVENTION

It is the object of the invention to further develop an information sign, especially a name plate, door plate or notice sign, in such a way that an aesthetic product of flat configuration is obtained, which ensures that the cover or decorative plate is securely held in an exchangeable fashion in the base body, but is protected from manipulations.

This object is achieved in accordance with the invention in such a way that two opposite longitudinal or narrow sides of the preferably rectangular or square cover or decorative plate and the adjacent frame parts of the base body are provided with groove-and-tongue latching connection.

The name plate, door plate or notice sign in accordance with the invention is thus protected in a simple manner and without the use of magnets against undesirable manipulations because the cover or decorative plate cannot be removed without tools and sits in a virtually seamless manner in the base body in the inserted state. Attempts to lift the plate by mere force of fingers by pressing up the cover plate or decorative plate will fail because a negative pressure in the sign body which forms in the closed system will counteract any such attempt. A respective forward bulging of the cover or decorative plate can be produced with a lifting tool such as a suction pad; so that the groove-and-tongue latching connection can be removed.

The decorative plate which is inserted in an exchangeable manner in the base body can be used directly as a data carrier, with the decorative plate being printable on the visible side for example. It is also possible to arrange the decorative plate at least partly in a transparent manner and print the same on the reverse side.

In accordance with an advantageous embodiment of the invention, a card-like data carrier is provided which can be inserted in the base body and which is fixed by the cover plate that is inserted into the base body and is arranged as least partly in a transparent manner. Data carriers with different content can thus be exchanged rapidly.

### BRIEF DESCRIPTION OF THE DRAWINGS

The invention will be explained below in closer detail by reference to the drawings, wherein:

FIG. 1 shows a sectional view of the apparatus in accordance with the invention, including the lifting tool;

FIG. 2 shows a sectional view according to FIG. 1 of the apparatus in accordance with the invention with inserted data carrier or decorative plate in two detailed variants;

FIG. 3 shows the reverse side of the apparatus in accordance with the invention in two detailed variants according to FIG. 2;

FIG. 4 shows the front side of the apparatus in accordance with the invention according to FIG. 1;

FIG. 5 and FIG. 6 show detailed variants of the groove-and-tongue latching connection of the apparatus according to FIG. 1;

FIG. 7 and FIG. 8 shows a sectional view and a top view of an embodiment of the frame connection, and

FIG. 9 shows the front view of an embodiment of the apparatus according to FIG. 1.

### DETAILED DESCRIPTION OF THE PREFERRED EMBODIMENTS

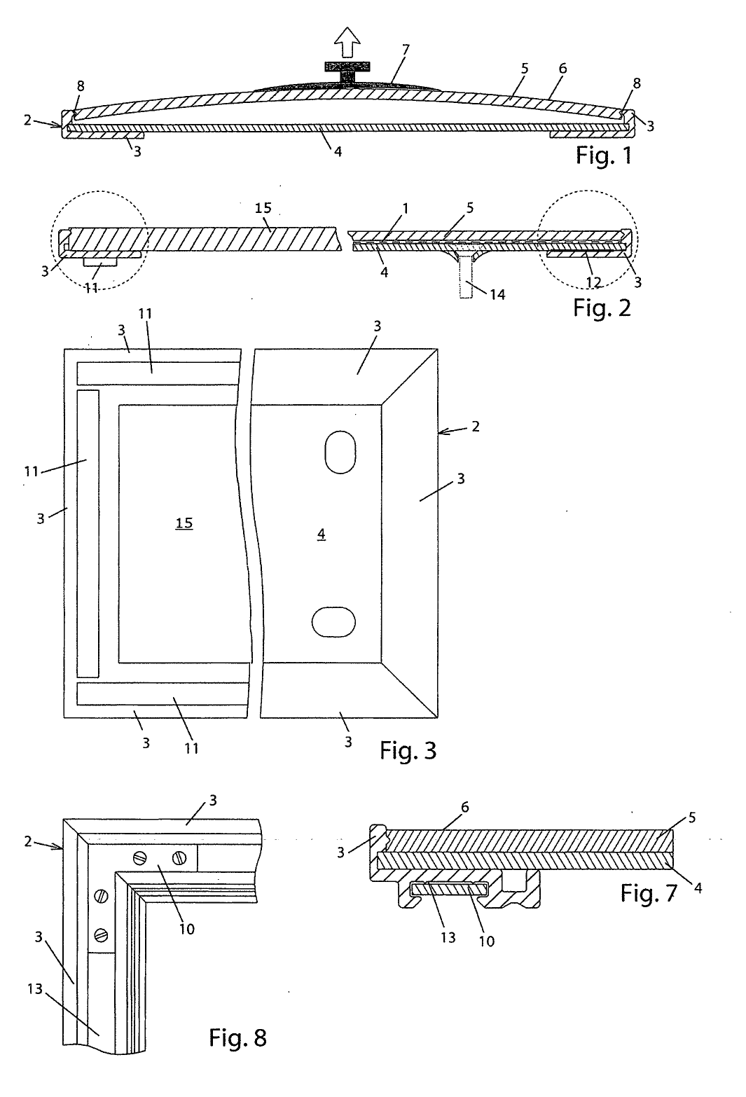

The embodiments of the invention as shown in FIGS. 1 to 9 show information or notice signs of the exchangeable frame type, comprising a base body 2 consisting of frame parts 3 and optionally a base plate 4, with a cover or decorative plate 5 or 15 being provided for covering, which plate can be clipped into the base body 2 by means of a groove-and-tongue latching connection 8.

As is shown in the embodiment according to FIG. 1, a transparent cover plate 5 is lifted in the direction of the arrow by means of a lifting tool acting upon the outside surface 6, preferably a suction pad 7, so that the illustrated forward bulging is obtained, with opposing groove-and-tongue latching regions 8 being uncoupled between the boundary regions of cover plate 5 and adjacent frame parts 3, and the cover plate 5 thus being removable. A data carrier 1 (cf. FIG. 2) in the format of the cover plate 5 is then inserted and the transparent cover plate 5 is inserted in reverse order, with the cover plate being slightly bulged during the insertion process. The cover plate 5 can consist of a thin transparent material such as plexiglass.

In accordance with the invention, two opposite narrow sides of the transparent cover plate 5 and the adjacent areas of the frame parts 3 are provided with a groove-and-tongue latching connection 8, with FIG. 5 showing one variant in detail, in which the groove is arranged in the narrow side of cover plate 5 and the tongue or nose in the L-shaped frame part 3. The outside surface 6 of the cover or decorative plate 5 forms a substantially flat plane with the adjacent frame parts 3 and abuts in a substantially seamless manner on the frame parts 3, so that a smooth surface is obtained which is easy to clean.

FIG. 6 shows a variant of the invention in which a small step is arranged between the cover plate 5 and the frame part 3, with a shoulder or the tongue of the groove-and-tongue latching connection 8 being arranged on the narrow side of the cover plate 5.

The groove-and-tongue latching connection 8 is arranged in a V-like manner in the cross section or it comprises at least one oblique contact surface which facilitates the opening and closing of the groove-and-tongue latching connection 8. In the illustrated examples, all contact surfaces of the groove-and-tongue latching connection 8 are inclined at an angle of approx. 45° to 60° in relation to the outside surface 6.

The frame parts 3 of the base body 2 can comprise a receiving groove 9 for insertion of the base plate 4. It can be connected by a glued connection 12 with the frame parts 3 (see FIGS. 5, 6).

It is also possible to connect the frame parts 3 of the base body 2 with the help of angle brackets 10 and screws (see FIGS. 7, 8). A respective frame profile comprises a receiving groove 13 for the angle brackets 10. The information to be displayed can also be printed onto the front side of the base plate 4 and can be visible through the transparent cover plate 5.

The frame parts 3 of the base body 2 can consist of a metal profile, preferably made of aluminum. It is also possible to produce the frame parts 3 of the base body 2 in an integral manner as an injection-molded part, preferably made of plastic.

The respective left parts of FIGS. 2 and 3 show a variant in which a decorative plate 15 printed for example with an illustration or a pictogram (see FIG. 9) is inserted by means of the groove-and-tongue latching connection into an integrally arranged base body 2. The wall mounting of the information sign can be made by means of adhesive strips 11.

The respective right parts of FIGS. 2 and 3 show a door plate of an office room for example, comprising a base body 2 glued together from four frame parts 3 and a base plate 4, which base body accommodates a data carrier 1 with the printed information. The data carrier 1 is fixed and covered by the transparent cover plate 5. Mounting of the apparatus is provided here by means of screws 14.

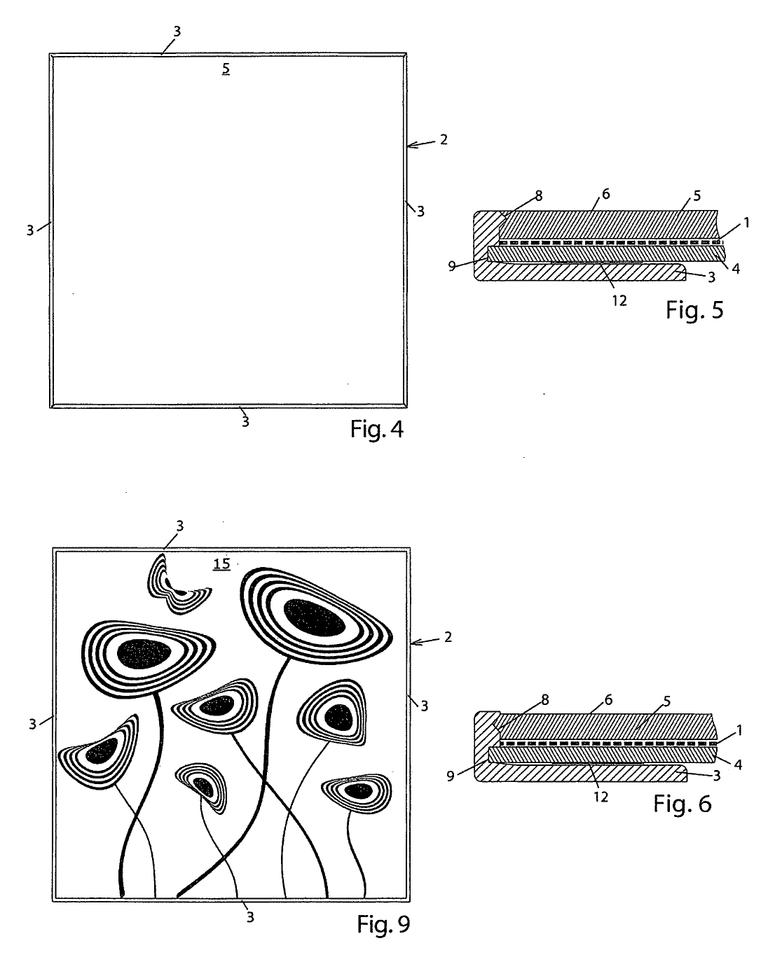

FIGS. 4 and 9 each show the front side of the information sign in accordance with the invention, in which only the transparent cover plate 5 or decorative plate 15 is shown, enclosed by the narrow frame parts 3, with all fastening elements remaining invisible.

What is claimed is:

1. An information sign, especially name plates, door plates or notice signs, comprising a base body made of frame parts and a cover plate or a decorative plate which is insertable in the base body, wherein the cover plate or decorative plate is lifted off by means of a lifting tool, acting upon the outside surface, so that a forward bulging of the cover plate or decorative plate is produced and the same is removable, wherein two opposite longitudinal or narrow sides of the rectangular or square cover plate or decorative plate and adjacent frame parts therefrom are provided with a groove-and-tongue latching connection.

2. An information sign according to claim 1, wherein the outside surface of the cover plate or decorative plate forms a substantially flat plane with the adjacent frame parts and abuts the frame parts in a substantially seamless manner.

3. An information sign according to claim 1, wherein the groove-and-tongue latching connection is arranged in a V-like manner in its cross section or comprises at least one oblique contact surface which facilitates the opening and closing of the groove-and-tongue latching connection.

4. An information sign according to claim 1, wherein the base body comprises a base plate.

5. An information sign according to claim 4, wherein the frame parts of the base body comprise a receiving groove for inserting the base plate.

6. An information sign according to claim 4, wherein the frame parts of the base body are connected with the base plate by gluing.

7. An information sign according to claim 1, wherein the lifting tool is a suction pad.

8. An information sign according to claim 1, wherein the frame parts of the base body are connected with the help of angle brackets.

9. An information sign according to claim 1, wherein the frame parts of the base body consist of a metal profile.

10. An information sign according to claim 1, wherein the frame parts of the base body are made integrally as an injection-molded part made of plastic.

11. An information sign according to claim 1, wherein a card-like data carrier is provided which is insertable into the base body and is fixed by the cover plate which is inserted into the base body and is at least partly transparent.

12. An information sign according to claim 1, wherein the decorative plate having a front side and a rear side is printed on the front side.

13. An information sign according to claim 1, wherein the decorative plate having a front side and a rear side is at least partly transparent and is printed on the rear side.
